(19) United States
(12) Patent Application Publication
(10) Pub. No.: US 2025/0292156 A1
(43) Pub. Date: Sep. 18, 2025

(54) PUSH OBJECT PROCESSING

(71) Applicant: TENCENT TECHNOLOGY (SHENZHEN) COMPANY LIMITED, Shenzhen (CN)

(72) Inventor: Wei DAI, Shenzhen (CN)

(73) Assignee: TENCENT TECHNOLOGY (SHENZHEN) COMPANY LIMITED, Shenzhen, GD (CN)

(21) Appl. No.: 19/222,760

(22) Filed: May 29, 2025

Related U.S. Application Data
(63) Continuation of application No. PCT/CN2024/073230, filed on Jan. 19, 2024.

(30) Foreign Application Priority Data
Mar. 20, 2023 (CN) 202310300482.1

(51) Int. Cl. G06N 20/00; G06F 3/0484

(52) U.S. Cl. CPC G06N 20/00; G06F 3/0484

(57) ABSTRACT

In a push object processing method, interaction object information corresponding to a target user is obtained. The interaction object information includes information of at least one object having an interaction relationship with the target user. A user description feature of the target user is determined based on the interaction object information. Interaction user information corresponding to a plurality of to-be-pushed objects is obtained. The interaction user information of each of the plurality of to-be-pushed objects includes information of at least one user having an interaction relationship with the respective to-be-pushed objects. Based on the interaction user information, object features corresponding to the plurality of to-be-pushed objects are determined. A candidate push object from the plurality of to-be-pushed objects is selected based on the user description feature and the object features.

### RELATED APPLICATIONS

The present application is a continuation of International Application No. PCT/CN2024/073230, filed on Jan. 19, 2024, which claims priority to Chinese Patent Application No. 202310300482.1, filed on Mar. 20, 2023. The entire disclosures of the prior applications are hereby incorporated by reference.

### FIELD OF THE TECHNOLOGY

This application relates to the field of internet technologies, including a push object processing method, and a method for training an object push model.

### BACKGROUND OF THE DISCLOSURE

With the development of internet technologies, internet platforms have become diversified, including, for example, video platforms, news platforms, and shopping platforms. These internet platforms may push content of interest to their users. For example, video platforms may push videos in which a user is interested to the user, news platforms may push news in which a user is interested to the user, and shopping platforms may push products in which a user is interested to the user.

In related technology, the internet platforms may recommend a similar object to the user with reference to an object that the user has historically interacted with. Such a push manner is based on a monotonous dimension, and has a problem of large overheads of communication resources caused by push of an object with a low matching degree.

### SUMMARY

Aspects of this disclosure include a push object processing method, a push object processing apparatus, and a method for training an object push model.

Examples of technical solutions of this disclosure may be implemented as follows:

An aspect of this disclosure provides a push object processing method. Interaction object information corresponding to a target user is obtained. The interaction object information includes information of at least one object having an interaction relationship with the target user. A user description feature of the target user is determined based on the interaction object information. Interaction user information corresponding to a plurality of to-be-pushed objects is obtained. The interaction user information of each of the plurality of to-be-pushed objects includes information of at least one user having an interaction relationship with the respective to-be-pushed objects. Based on the interaction user information, object features corresponding to the plurality of to-be-pushed objects are determined. A candidate push object from the plurality of to-be-pushed objects is selected based on the user description feature and the object features.

An aspect of this disclosure provides a method for training an object push model. A training sample is obtained. The training sample includes interaction object information corresponding to a sample user, interaction user information corresponding to a sample push object, and an interaction label. Based on the interaction object information corresponding to the sample user, a sample user description feature of the sample user is obtained from a user description feature extraction network in a to-be-trained object push model. Based on the interaction user information corresponding to the sample push object, a sample object feature corresponding to the sample push object is obtained from an object feature extraction network in the to-be-trained object push model. A model loss is determined based on the sample user description feature, the sample object feature, and the interaction label. Parameters of the to-be-trained object push model are adjusted based on the model loss until a stop condition of model training is satisfied to obtain a trained object push model that is configured to select a candidate push object from a plurality of to-be-pushed objects for a target user.

An aspect of this disclosure provides a push object processing apparatus. The apparatus includes processing circuitry configured to obtain interaction object information corresponding to a target user. The interaction object information includes information of at least one object having an interaction relationship with the target user. The processing circuitry is configured to determine a user description feature of the target user based on the interaction object information. The processing circuitry is configured to obtain interaction user information corresponding to a plurality of to-be-pushed objects. The interaction user information of each of the plurality of to-be-pushed objects includes information of at least one user having an interaction relationship with the respective to-be-pushed objects. Based on the interaction user information, the processing circuitry is configured to determine object features corresponding to the plurality of to-be-pushed objects. The processing circuitry is configured to select a candidate push object from the plurality of to-be-pushed objects based on the user description feature and the object features.

Details of one or more aspects of this disclosure are provided in the accompanying drawings and descriptions below. Other features, objectives, and advantages of this disclosure become apparent from the specification, the drawings, and the claims.

### BRIEF DESCRIPTION OF THE DRAWINGS

To describe the technical solutions in aspects of this disclosure, the following briefly describes the accompanying drawings. The accompanying drawings in the following descriptions show merely examples of aspects of this disclosure, and a person of ordinary skill in the art may still derive other drawings from these disclosed accompanying drawings.

FIG. 1 is a diagram of an application environment of a push object processing method according to an aspect.

FIG. 2 is a schematic flowchart of a push object processing method according to an aspect.

FIG. 3 is a schematic flowchart of a method for training an object push model according to an aspect.

FIG. 4 is a schematic diagram of a structure of an object push model according to an aspect.

FIG. 5 is a schematic flowchart of a push object processing method according to another aspect.

FIG. 6 is a schematic flowchart of a push process in a video push scenario according to an aspect.

FIG. 7 is a schematic flowchart of updating interaction user information according to an aspect.

FIG. 8 is a block diagram of a structure of a push object processing apparatus according to an aspect.

FIG. 9 is a block diagram of a structure of an apparatus for training an object push model according to an aspect.

FIG. 10 is a diagram of an internal structure of a computer device according to an aspect.

### DETAILED DESCRIPTION

Technical solutions in aspects of this disclosure are described below with reference to the accompanying drawings in aspects of this disclosure. The described aspects are merely some rather than all of aspects of this disclosure. All other aspects obtained by a person of ordinary skill in the art based on this disclosure shall fall within the scope of this disclosure. Further, the descriptions of the terms are provided as examples only and are not intended to limit the scope of the disclosure.

A push object processing method provided in this aspect of this disclosure may be applied to an application environment shown in FIG. 1. A terminal 102 communicates with a server 104 through a network. A data storage system may store data that the server 104 needs to process. The data storage system may be integrated on the server 104, or may be placed on a cloud or another server. The push object processing method provided in this aspect of this disclosure may be independently performed by the terminal 102 or the server 104, or may be jointly performed by the terminal 102 and the server 104. This is not limited in this aspect of this disclosure. For example, the method is independently performed by the server 104. The server 104 may obtain interaction object information corresponding to a target user, and obtain a user description feature of the target user based on the interaction object information. The interaction object information includes information of at least one object having an interaction relationship with the target user. In addition, the server 104 may obtain interaction user information corresponding to each to-be-pushed object, and determine, based on the interaction user information, an object feature corresponding to a corresponding to-be-pushed object. The interaction user information includes information of at least one user having an interaction relationship with the corresponding to-be-pushed object. Then, the server 104 may select a candidate push object from to-be-pushed objects based on the user description feature and object features respectively corresponding to the to-be-pushed objects. The candidate push object is configured for determining a target push object to be pushed to the target user.

The terminal 102 may be, but is not limited to, a personal computer, a notebook computer, a smartphone, a tablet, an internet of things device, or a portable wearable device. The internet of things device may be a smart speaker, a smart television, a smart air conditioner, a smart on-board device, or the like. The portable wearable device may be a smart watch, a smart band, a head-mounted device, or the like. The server 104 may be an independent physical server, or may be a server cluster including a plurality of physical servers or a distributed system, or may be a cloud server that provides a cloud computing service.

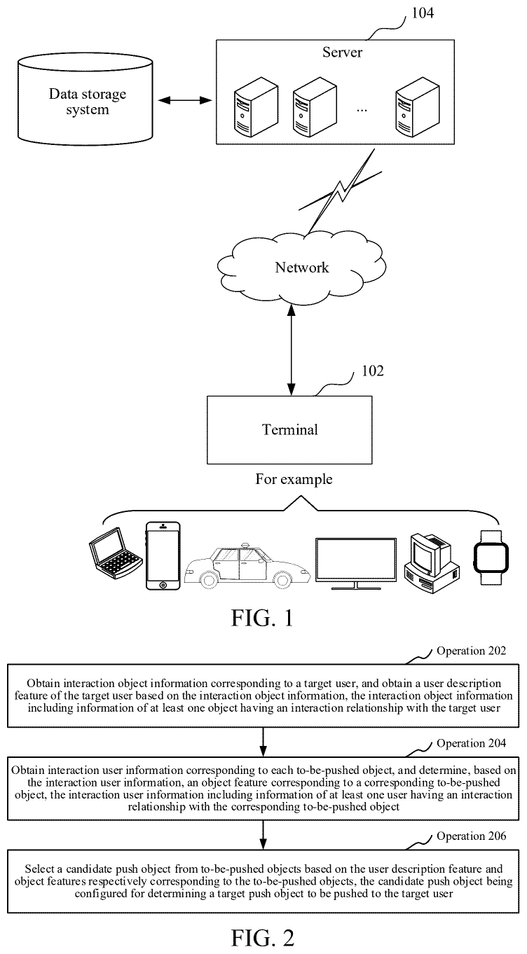

In some aspects, as shown in FIG. 2, a push object processing method is provided. An example in which the method is applied to a computer device is used for description. The computer device may be the terminal or the server in FIG. 1, or a system including the terminal and the server. The method includes the following operations:

Operation 202: Obtain interaction object information corresponding to a target user, and obtain a user description feature of the target user based on the interaction object information, the interaction object information including information of at least one object having an interaction relationship with the target user. For example, interaction object information corresponding to a target user is obtained. The interaction object information includes information of at least one object having an interaction relationship with the target user. A user description feature of the target user is determined based on the interaction object information.

Software adapted to configuration of the terminal may be installed on the terminal. For example, when the terminal is a smartphone, an application may be installed on the terminal. The application is used as an example for description in this aspect of this disclosure. The application may be a video application, a news application, a shopping application, or the like. This is not limited in this aspect of this disclosure.

The target user is a user to which an object needs to be recommended, and is a specific user. The target user may be uniquely identified in the application by using a user identifier of the target user, and the user identifier is unique. The interaction object information corresponding to the target user may be interaction object information corresponding to the user identifier of the target user. The interaction object information corresponding to the user identifier may be determined based on a historical operation record provided or authorized by the target user. The user identifier of the corresponding target user in the historical operation record records information of an object having an interaction relationship with the target user.

During specific implementation, the user identifier of the target user may be a unique identifier that is allocated by the application to the target user when the application is used in a case that the target user does not log in to the application, or may be an identifier used by the target user in a login process when the application is used in a case that the target user logs in to the application. The identifier used by the target user in the login process may be a unique identifier that is entered by the target user when the target user registers in the application, or an identifier that is allocated by the application to the target user.

For example, the user identifier of the target user may be unique identification information (user information, uin for short) allocated by the application to the target user, or may be a unique user name, user profile picture, or the like entered by the target user. A form of the target user is not limited in this aspect of this disclosure.

When detecting that usage for the application by the target user satisfies a preset condition, the terminal may send an object push request to the server. After receiving the object push request, the server starts to perform the push object processing method provided in this aspect of this disclosure.

During specific implementation, that the usage for the application by the target user satisfies the preset condition may include: the target user opens the application, the target user continues to use the application for more than preset duration after opening the application, or a quantity of objects tapped on the application after the target user opens the application exceeds a preset quantity. This is not limited in this aspect of this disclosure.

The object push request may carry a user identifier used when the target user operates on the application. After receiving the object push request, the server may parse the object push request, to obtain the user identifier of the target user.

During specific implementation, the object in this aspect of this disclosure is related to a type of the application. In a case that the application is a video application, the object in this aspect of this disclosure may be a video. In a case that the application is a shopping application, the object in this aspect of this disclosure may be a product. In a case that the application is a news application, the object in this aspect of this disclosure may be news.

The interaction object information corresponding to the target user may include the information of the at least one object having the interaction relationship with the target user.

During specific implementation, the server may use, as the object having the interaction relationship with the target user, an object that the target user interacts with in a process in which a user with the user identifier of the target user operates on the application. The interaction here may be understood as performing an interaction operation on the object. The interaction operation may include at least one of tapping, like, collecting, forwarding, or sharing. Correspondingly, the interaction relationship may be a relationship indicated by the interaction operation. For example, the interaction relationship may include at least one of a tapping relationship, a like relationship, a collecting relationship, a forwarding relationship, or a sharing relationship.

For example, the interaction relationship includes the tapping relationship, the like relationship, the collecting relationship, the forwarding relationship, and the sharing relationship. Information of at least one object having the tapping relationship with the target user, information of at least one object having the like relationship with the target user, information of at least one object having the collecting relationship with the target user, information of at least one object having the forwarding relationship with the target user, and information of at least one object having the sharing relationship with the target user may be obtained. The interaction object information corresponding to the target user is determined based on the obtained information.

The information of the object having the interaction relationship with the target user may be object attribute information. The object attribute information may include object identification information (an identity document, ID for short), and may further include object description information, and the like. The object description information may include an author tag, a title, a size of occupied space, and the like. This is not limited in this aspect of this disclosure.

Information of at least one object corresponding to each of different interaction relationships may be arranged according to a preset rule, to obtain the interaction object information corresponding to the target user. For example, arrangement may be performed according to an order of the tapping relationship, the like relationship, the collecting relationship, the forwarding relationship, and the sharing relationship, or may be performed according to another order. An arrangement order is not limited in this aspect of this disclosure.

An example is provided below.

Assuming that the application is a video application, and the target user is uin 1, the server may query a database for a video having the tapping relationship with uin 1. Assuming that there is a video 1, a video 2, and a video 3, an ID of the video 1 is ID 1, an ID of the video 2 is ID 2, and an ID of the video 3 is ID 3. The server may query the database for a video having the collecting relationship with uin 1. Assuming that there are a video 4 and a video 5, an ID of the video 4 is ID 4, and an ID of the video 5 is ID 5. The server may query the database for a video having a forwarding relationship with uin 1. Assuming that there is a video 6, an ID of the video 6 is ID 6. ID 1, ID 2, ID 3, ID 4, ID 5, and ID 6 may be used as the interaction object information corresponding to the target user.

After obtaining the interaction object information corresponding to the target user, the server may obtain the user description feature of the target user based on the interaction object information.

During specific implementation, the server may perform feature extraction on the interaction object information corresponding to the target user, to obtain the user description feature of the target user.

For example, the server may obtain an object push model through pre-training. The server may input the interaction object information corresponding to the target user into the object push model, and the object push model performs feature extraction on the interaction object information, to obtain the user description feature of the target user. The object push model may use a neural network (Transformer) architecture, a recurrent neural network (RNN for short) architecture, a convolutional neural network (CNN for short) architecture, or the like. An architecture form of the object push model is not limited in this aspect of this disclosure.

The foregoing object push model may include a user description feature extraction network. The interaction object information corresponding to the target user may be inputted into the user description feature extraction network, and a feature outputted by the user description feature extraction network is used as the user description feature of the target user.

During specific implementation, the server may further obtain attribute information of the target user. The attribute information includes at least one of user description information or identification information. The server may obtain the user description feature of the target user based on the interaction object information corresponding to the target user and the attribute information of the target user.

For example, the server may obtain the object push model through pre-training. The server may input the interaction object information corresponding to the target user and the attribute information of the target user into the object push model, and the object push model performs feature extraction on the interaction object information and the attribute information, to obtain the user description feature of the target user.

The foregoing object push model may include the user description feature extraction network. The interaction object information corresponding to the target user and the attribute information of the target user may be inputted into the user description feature extraction network, and a feature outputted by the user description feature extraction network is used as the user description feature of the target user.

For example, the user description feature extraction network may perform the feature extraction on the interaction object information and the attribute information in the following manner. The server may perform feature extraction on the interaction object information corresponding to the target user, to obtain a feature extraction result corresponding to the interaction object information, and may further perform feature extraction on the attribute information of the target user, to obtain a feature extraction result corresponding to the attribute information. The server may concatenate the feature extraction result corresponding to the interaction object information and the feature extraction result corresponding to the attribute information, to obtain a user concatenated feature, and perform feature extraction on the user concatenated feature again, to obtain the user description feature of the target user.

In a case that the user description feature of the target user is obtained by using a trained object push model, a length of the interaction object information corresponding to the target user may be processed to a length adapted to the object push model, and the user description feature of the target user is obtained based on processed interaction object information by using the trained object push model.

During specific implementation, in a case that the length of the interaction object information corresponding to the target user is greater than an input length of interaction object information corresponding to the object push model, the server may perform truncation processing on the interaction object information corresponding to the target user, so that a length of interaction object information obtained through the truncation processing is adapted to the object push model. In a case that the length of the interaction object information corresponding to the target user is less than an input length of interaction object information corresponding to the object push model, the server may perform supplementary processing on the interaction object information corresponding to the target user, so that a length of interaction object information obtained through the supplementary processing is adapted to the object push model.

For example, the input length of the interaction object information corresponding to the object push model is 5, and the obtained interaction object information corresponding to the target user is: ID 1, ID 2, ID 3, ID 4, ID 5, and ID 6. Truncation processing may be performed on the interaction object information, to obtain an interaction object sequence with a length of 5. The interaction object sequence with the length of 5 may be used as the processed interaction object information. The user description feature of the target user may be obtained based on the processed interaction object information by using the trained object push model.

Operation 204: Obtain interaction user information corresponding to each to-be-pushed object, and determine, based on the interaction user information, an object feature corresponding to a corresponding to-be-pushed object, the interaction user information including information of at least one user having an interaction relationship with the corresponding to-be-pushed object. For example, interaction user information corresponding to a plurality of to-be-pushed objects is obtained. The interaction user information of each of the plurality of to-be-pushed objects includes information of at least one user having an interaction relationship with the respective to-be-pushed objects. Based on the interaction user information, object features corresponding to the plurality of to-be-pushed objects are determined.

The server may use an object in an object pool as the to-be-pushed object. The user may upload completed data to the server by using the application. The object pool is configured for storing an object uploaded in a preset time period. The preset time period may be last N days, N is a positive number, and a specific value of N may be set flexibly based on an actual situation. The method provided in this aspect of this disclosure may be applied to a data retrieval scenario. The object pool may be a retrieval pool.

The interaction user information corresponding to the to-be-pushed object includes the information of the at least one user having the interaction relationship with the to-be-pushed object. A user who has performed a preset operation on the to-be-pushed object may be used as the user having the interaction relationship with the to-be-pushed object. The preset operation may include at least one of tapping, like, collecting, forwarding, or sharing. Correspondingly, the interaction relationship may be a relationship indicated by the preset operation. For example, the interaction relationship may include at least one of a tapping relationship, a like relationship, a collecting relationship, a forwarding relationship, or a sharing relationship.

For example, the interaction relationship includes the tapping relationship, the like relationship, the collecting relationship, the forwarding relationship, and the sharing relationship. Information of at least one user having the tapping relationship with the to-be-pushed object, information of at least one user having the like relationship with the to-be-pushed object, information of at least one user having the collecting relationship with the to-be-pushed object, information of at least one user having the forwarding relationship with the to-be-pushed object, and information of at least one user having the sharing relationship with the to-be-pushed object may be obtained. The interaction user information corresponding to the to-be-pushed object is determined based on the obtained information.

The interaction relationship included in the interaction object information may be consistent with the interaction relationship included in the interaction user information. For example, in a case that the interaction relationship included in the interaction object information is the tapping relationship, the collecting relationship, and the forwarding relationship, the interaction relationship included in the interaction user information may also be the tapping relationship, the collecting relationship, and the forwarding relationship.

The information of the user having the interaction relationship with the to-be-pushed object may be attribute information of the user. The attribute information may include identification information, user description information, and the like. This is not limited in this aspect of this disclosure.

Information of at least one user corresponding to each of different interaction relationships may be arranged according to a preset rule, to obtain the interaction user information corresponding to the to-be-pushed object. For example, arrangement may be performed according to an order of the tapping relationship, the like relationship, the collecting relationship, the forwarding relationship, and the sharing relationship, or may be performed according to another order. An arrangement order is not limited in this aspect of this disclosure.

An example is provided below.

Assuming that the application is a video application, the object pool is a video pool, and each video in the video pool may be used as a to-be-pushed object, for a video in the video pool, the server may query a database for a user having the tapping relationship with the video. Assuming that there are a user 1, a user 2, and a user 3, uin of the user 1 is uin 1, uin of the user 2 is uin 2, and uin of the user 3 is uin 3. The server may query the database for a user having the collecting relationship with the video. Assuming that there are a user 4 and a user 5, uin of the user 4 is uin 4, and uin of the user 5 is uin 5. The server may query the database for a user having the forwarding relationship with the video. Assuming that there is a user 6, uin of the user 6 is uin 6. uin 1, uin 2, uin 3, uin 4, uin 5, and uin 6 may be used as the interaction user information corresponding to the to-be-pushed object.

After obtaining the interaction user information corresponding to the to-be-pushed object, the server may obtain the object feature corresponding to the to-be-pushed object based on the interaction user information.

During specific implementation, the server may perform feature extraction on the interaction user information corresponding to the to-be-pushed object, to obtain the object feature corresponding to the to-be-pushed object.

For example, the server may obtain the object push model through pre-training. The server may input the interaction user information corresponding to the to-be-pushed object into the object push model, and the object push model performs feature extraction on the interaction user information, to obtain the object feature corresponding to the to-be-pushed object.

The foregoing object push model may include an object feature extraction network. The interaction user information corresponding to the to-be-pushed object may be inputted into the object feature extraction network, and a feature outputted by the object feature extraction network is used as the object feature corresponding to the to-be-pushed object.

During specific implementation, the server may further obtain object attribute information corresponding to the to-be-pushed object. The object attribute information includes at least one of object description information or object identification information. The server may obtain the object feature corresponding to the to-be-pushed object based on the interaction user information corresponding to the to-be-pushed object and the object attribute information corresponding to the to-be-pushed object.

For example, the server may obtain the object push model through pre-training. The server may input the interaction user information corresponding to the to-be-pushed object and the object attribute information corresponding to the to-be-pushed object into the object push model, and the object push model performs feature extraction on the interaction user information and the object attribute information, to obtain the object feature corresponding to the to-be-pushed object.

The foregoing object push model may include the object feature extraction network. The interaction user information corresponding to the to-be-pushed object and the object attribute information corresponding to the to-be-pushed object may be inputted into the object feature extraction network, and a feature outputted by the object feature extraction network is used as the object feature corresponding to the to-be-pushed object.

For example, the object feature extraction network may perform feature extraction on the interaction user information and the object attribute information in the following manner. The server may perform feature extraction on the interaction user information corresponding to the to-be-pushed object, to obtain a feature extraction result corresponding to the interaction user information, and may further perform feature extraction on the object attribute information corresponding to the to-be-pushed object, to obtain a feature extraction result corresponding to the object attribute information. The server may concatenate the feature extraction result corresponding to the interaction user information and the feature extraction result corresponding to the object attribute information, to obtain an object concatenated feature, and perform feature extraction on the object concatenated feature again, to obtain the object feature corresponding to the to-be-pushed object.

In a case that the object feature corresponding to the to-be-pushed object is obtained by using the trained object push model, a length of the interaction user information corresponding to the to-be-pushed object may be processed to a length adapted to the object push model, and the object feature corresponding to the to-be-pushed object is obtained based on processed interaction user information by using the trained object push model.

During specific implementation, in a case that the length of the interaction user information corresponding to the to-be-pushed object is greater than an input length of interaction user information corresponding to the object push model, the server may perform truncation processing on the interaction user information corresponding to the to-be-pushed object, so that a length of interaction user information obtained through the truncation processing is adapted to the object push model. In a case that the length of the interaction user information corresponding to the to-be-pushed object is less than an input length of interaction user information corresponding to the object push model, the server may perform supplementary processing on the interaction user information corresponding to the to-be-pushed object, so that a length of interaction user information obtained through the supplementary processing is adapted to the object push model.

For example, the input length of the interaction user information corresponding to the object push model is 5, and the obtained interaction user information corresponding to the to-be-pushed object is: uin 1, uin 2, uin 3, uin 4, uin 5, and uin 6. Truncation processing may be performed on the interaction user information, to obtain an interaction user sequence with a length of 5. The interaction user sequence with the length of 5 may be used as the processed interaction user information. The object feature corresponding to the to-be-pushed object may be obtained based on the processed interaction user information by using the trained object push model.

Operation 206: Select a candidate push object from to-be-pushed objects based on the user description feature and object features respectively corresponding to the to-be-pushed objects, the candidate push object being configured for determining a target push object to be pushed to the target user. For example, a candidate push object from the plurality of to-be-pushed objects is selected based on the user description feature and the object features.

The server may calculate a correlation between the user description feature and the object features respectively corresponding to the to-be-pushed objects, and select the candidate push object from the to-be-pushed objects based on the correlation.

During specific implementation, the correlation may be any parameter that can represent a correlation degree between two features. For example, the correlation may be an inner product, a Euclidean distance, or the like. This is not limited in this aspect of this disclosure.

During specific implementation, after obtaining the correlation between the user description feature and the object features respectively corresponding to the to-be-pushed objects, the server may use a to-be-pushed object corresponding to an object feature of which a correlation satisfies a preset condition as the candidate push object. For example, the correlation satisfying the preset condition may be that the correlation is greater than a preset correlation threshold, the correlation ranks before a preset rank, or the like. This is not limited in this aspect of this disclosure.

An example is provided below.

The server may calculate an inner product between the user description feature and the object features respectively corresponding to the to-be-pushed objects, sort object features respectively corresponding to all the to-be-pushed objects in descending order of inner products, and use to-be-pushed objects corresponding to a preset quantity of object features that rank high as candidate push objects.

A process of selecting the candidate push object from the object pool may be referred to as retrieval processing. After obtaining the candidate push object, the server may continue to perform pre-ranking and ranking processes based on the candidate push object, and use a preset quantity of objects that rank high in a ranking result as target push objects to be pushed to the target user.

After determining the target push object, the server sends the target push object to the terminal, and the terminal displays the received object for the target user to view.

In the foregoing aspect, the interaction object information corresponding to the target user is obtained, and the user description feature of the target user is obtained based on the interaction object information. The interaction object information includes information of at least one object having an interaction relationship with the target user. In addition, the interaction user information corresponding to each to-be-pushed object is obtained, and the object feature corresponding to the corresponding to-be-pushed object is determined based on the interaction user information. The interaction user information includes information of at least one user having an interaction relationship with the corresponding to-be-pushed object. The interaction object information and the interaction user information form a dual behavior sequence. The candidate push object is selected from to-be-pushed objects based on the user description feature and object features respectively corresponding to the to-be-pushed objects. In a process of selecting the candidate push object, objects having interaction relationships with the target user are considered, and users who perform interaction operations on the to-be-pushed object are considered. In this manner, an object that is similar to an object interacted with the target user and that is interacted by a user having a similar orientation of interest may be selected, and the selected candidate push object may be configured for determining the target push object to be pushed to the target user. This increases a matching degree between the target push object and the target user, and reduces communication resource overheads caused by push of an object with a low matching degree.

In some aspects, obtaining the user description feature of the target user based on the interaction object information and determining, based on the interaction user information, the object feature corresponding to the corresponding to-be-pushed object are both implemented by using the trained object push model.

The server may input the interaction object information and the interaction user information into the trained object push model, and the object push model performs the feature extraction on the interaction object information and the interaction user information, to obtain the user description feature of the target user and the object feature corresponding to the corresponding to-be-pushed object.

During specific implementation, the trained object push model includes the user description feature extraction network and the object feature extraction network. The server may input the interaction object information into the user description feature extraction network, and the user description feature extraction network performs feature extraction on the interaction object information, to obtain the user description feature of the target user. The server may input the interaction user information into the object feature extraction network, and the object feature extraction network performs feature extraction on the interaction user information, to obtain the object feature corresponding to the corresponding to-be-pushed object.

The server may further obtain the attribute information of the target user and the object attribute information corresponding to the to-be-pushed object. The server may determine the user description feature of the target user and the object feature corresponding to the corresponding to-be-pushed object based on the interaction object information corresponding to the target user, the attribute information of the target user, the interaction user information corresponding to the to-be-pushed object, and the object attribute information corresponding to the to-be-pushed object.

During specific implementation, the trained object push model includes the user description feature extraction network and the object feature extraction network. The server may input the interaction object information and the attribute information into the user description feature extraction network, and the user description feature extraction network performs feature extraction on the interaction object information and the attribute information, to obtain the user description feature of the target user. The server may input the interaction user information and the object attribute information into the object feature extraction network, and the object feature extraction network performs feature extraction on the interaction user information and the object attribute information, to obtain the object feature corresponding to the corresponding to-be-pushed object.

In the foregoing aspect, the user description feature of the target user and the object feature corresponding to the corresponding to-be-pushed object are determined based on the interaction object information and the interaction user information by using the trained object push model. The interaction object information and the interaction user information form a dual behavior sequence. An object that is similar to an object interacted with the target user and that is interacted by a user having a similar orientation of interest may be selected from the to-be-pushed objects based on the user description feature and object features respectively corresponding to the to-be-pushed objects. This increases a matching degree between an object pushed to the target user and the target user.

In some aspects, determining, based on the interaction object information and the interaction user information by using the trained object push model, the user description feature of the target user and the object feature corresponding to the corresponding to-be-pushed object includes: determining the user description feature of the target user based on the interaction object information by using the user description feature extraction network in the trained object push model; and determining, based on the interaction user information by using the object feature extraction network in the trained object push model, the object feature corresponding to the corresponding to-be-pushed object.

The trained object push model includes the user description feature extraction network and the object feature extraction network. The server may input the interaction object information into the user description feature extraction network, and the user description feature extraction network performs feature extraction on the interaction object information, to use a feature outputted by the user description feature extraction network as the user description feature of the target user. The server may input the interaction user information into the object feature extraction network, and the object feature extraction network performs feature extraction on the interaction user information, to use a feature outputted by the object feature extraction network as the object feature corresponding to the corresponding to-be-pushed object.

During specific implementation, the server may further obtain the attribute information of the target user and the object attribute information corresponding to the to-be-pushed object. While inputting the interaction object information into the user description feature extraction network, the server may further input the attribute information into the user description feature extraction network, and the user description feature extraction network performs feature extraction on the interaction object information and the attribute information, to obtain the user description feature of the target user. While inputting the interaction user information into the object feature extraction network, the server may further input the object attribute information into the object feature extraction network, and the object feature extraction network performs feature extraction on the interaction user information and the object attribute information, to obtain the object feature corresponding to the corresponding to-be-pushed object.

In the foregoing aspect, the user description feature of the target user is determined based on the interaction object information by using the user description feature extraction network in the trained object push model. The object feature corresponding to the corresponding to-be-pushed object is determined based on the interaction user information by using the object feature extraction network in the trained object push model. Subsequently, the target push object to be pushed to the target user may be determined based on the user description feature and the object feature. In this manner, an object that is similar to an object interacted with the target user and that is interacted by a user having a similar orientation of interest may be selected from the to-be-pushed objects. This increases a matching degree between an object pushed to the target user and the target user.

In some aspects, determining the user description feature of the target user based on the interaction object information by using the user description feature extraction network in the trained object push model includes: obtaining the attribute information of the target user, the attribute information including at least one of the user description information or the identification information; separately performing feature extraction on the interaction object information and the attribute information, to obtain a first target feature corresponding to the interaction object information and a second target feature corresponding to the attribute information; concatenating the first target feature and the second target feature, to obtain a user concatenated feature; and performing feature extraction on the user concatenated feature, to obtain the user description feature of the target user.

The attribute information includes at least one of the user description information or the identification information.

During specific implementation, the attribute information of the target user may include only the user description information, only the identification information, or both the user description information and the identification information.

The user description feature extraction network includes an initial feature extraction layer, a feature concatenation layer, and a multi-layer perceptron (MLP for short). Feature extraction may be separately performed on the interaction object information and the attribute information through the initial feature extraction layer, to obtain the first target feature corresponding to the interaction object information and the second target feature corresponding to the attribute information. The first target feature and the second target feature may be concatenated through the feature concatenation layer, to obtain the user concatenated feature. Feature extraction may be performed on the user concatenated feature by using the MLP, to obtain the user description feature of the target user.

In the foregoing aspect, a specific manner in which the user description feature extraction network extracts the user description feature is described. The user description feature may be configured for selecting the object that is similar to the object interacted with the target user. This increases the matching degree between the object pushed to the target user and the target user.

In some aspects, determining, based on the interaction user information by using the object feature extraction network in the trained object push model, the object feature corresponding to the corresponding to-be-pushed object includes: obtaining the object attribute information corresponding to the to-be-pushed object, the object attribute information including at least one of the object description information or the object identification information; separately performing feature extraction on the interaction user information and the object attribute information, to obtain a third target feature corresponding to the interaction user information and a fourth target feature corresponding to the object attribute information; concatenating the third target feature and the fourth target feature, to obtain an object concatenated feature; and performing feature extraction on the object concatenated feature, to obtain the object feature corresponding to the to-be-pushed object.

The object attribute information includes at least one of the object description information or the object identification information.

During specific implementation, the object attribute information corresponding to the target user may include only the object description information, only the object identification information, or both the object description information and the object identification information.

The object feature extraction network includes an initial feature extraction layer, a feature concatenation layer, and a multi-layer perceptron (MLP for short). Feature extraction may be separately performed on the interaction user information and the object attribute information through the initial feature extraction layer, to obtain the third target feature corresponding to the interaction user information and the fourth target feature corresponding to the object attribute information. The third target feature and the fourth target feature may be concatenated through the feature concatenation layer, to obtain the object concatenated feature. Feature extraction may be performed on the object concatenated feature by using the MLP, to obtain the object feature corresponding to the to-be-pushed object.

In the foregoing aspect, a specific manner in which the object feature extraction network extracts the object feature is described. The object feature may be used for selecting the object that is interacted by the user having a similar orientation of interest. This increases the matching degree between the object pushed to the target user and the target user.

In some aspects, training operations for the trained object push model includes: obtaining a training sample, the training sample including: interaction object information corresponding to a sample user, interaction user information corresponding to a sample push object, and an interaction label; obtaining, based on the interaction object information corresponding to the sample user, a sample user description feature of the sample user by using a user description feature extraction network in a to-be-trained object push model; obtaining, based on the interaction user information corresponding to the sample push object, a sample object feature corresponding to the sample push object by using an object feature extraction network in the to-be-trained object push model; and determining a model loss based on the sample user description feature, the sample object feature, and the interaction label, and performing parameter adjustment on the to-be-trained object push model based on the model loss until a stop condition of model training is satisfied, to obtain a trained object push model.

After a user performs an interaction operation on an object on the application, the server may record information such as a user identifier used by the user on the application, object identifier information of the object, and an interaction relationship indicated by the interaction operation, to generate a group of historical data. As each user continuously performs an interaction operation on the application, the server may obtain a plurality of groups of historical data, and the server may store the historical data in a database.

The server may use a user in any piece of historical data as the sample user. The server may search all historical data stored in the database for information of at least one object having an interaction relationship with the sample user, and use the found information of the at least one object as the interaction object information corresponding to the sample user.

Any object in an object pool may be used as the sample push object. The server may search all historical data stored in the database for users who have performed interaction operations on the sample push object, and determine, based on the found users, the interaction user information corresponding to the sample push object.

The server may search the sample user in the users that have performed the interaction operations on the sample push object. If the sample user can be found, it is determined that the sample user has performed an interaction operation on the sample push object, the sample push object is determined as a positive sample, and the interaction label is set to “interacted”, or is set to a preset value corresponding to “interacted”. If the sample user cannot be found, it is determined that the sample user has not performed an interaction operation on the sample push object, the sample push object is determined as a negative sample, and the interaction label is set to no interaction, or set to a preset value corresponding to no interaction.

The to-be-trained object push model includes the user description feature extraction network and the object feature extraction network. The server may obtain attribute information of the sample user. The server may input the interaction object information and the attribute information corresponding into the sample user to the user description feature extraction network, to obtain the sample user description feature of the sample user. The server may obtain object attribute information corresponding to the sample push object, and the server may input the interaction user information and the object attribute information corresponding to the sample push object into the object feature extraction network, to obtain the sample object feature corresponding to the sample push object.

After obtaining the sample user description feature and the sample object feature, the server may calculate the model loss based on the sample user description feature, the sample object feature, and the interaction label by using a preset loss function, and may determine, based on the model loss, whether a current object push model satisfies the stop condition of the model training. In a case that the current object push model satisfies the stop condition of the model training, the current object push model is used as the trained object push model. In a case that the current object push model does not satisfy the stop condition of the model training, the parameter adjustment is performed on the to-be-trained object push model based on the model loss until the stop condition of the model training is satisfied, to obtain the trained object push model.

In the foregoing aspect, the training operations for the object push model are described. In a training process, on a sample user side, the interaction object information corresponding to the sample user is inputted, and on a sample push object side, the interaction user information corresponding to the sample push object is inputted. The interaction object information and the interaction user information form a dual behavior sequence, so that the model can learn a similarity of interaction habits between users and a similarity between objects in which the users are interested, thereby improving an object matching effect of the object push model.

In some aspects, selecting the candidate push object from the to-be-pushed objects based on the user description feature and object features respectively corresponding to the to-be-pushed objects includes: performing clustering processing on the object feature corresponding to each to-be-pushed object, to obtain a plurality of clusters; selecting a target cluster from the plurality of clusters based on a correlation between the user description feature and a cluster center corresponding to each cluster; and selecting the candidate push object from the to-be-pushed objects based on a correlation between the user description feature and each object feature in the target cluster.

The server may select a preset quantity of object features in various manners from object features corresponding to all the to-be-pushed objects as cluster centers, and then for each remaining object feature, the server may classify the object feature to a cluster center closest to the object feature, to obtain a plurality of initial clusters. For each initial cluster, a new cluster center is recalculated based on each object feature in the cluster, and the foregoing classification operation is repeatedly performed based on the new cluster center. When a quantity of classification operations reaches a preset quantity threshold, or when classified object feature satisfies a preset condition, a formed cluster is used as a final cluster.

The correlation may be any parameter that can represent a correlation degree between two features. For example, the correlation may be an inner product, a Euclidean distance, or the like. This is not limited in this aspect of this disclosure.

For example, the server may calculate an inner product between the user description feature and a cluster center corresponding to each cluster, and use a cluster corresponding to a cluster center having a largest inner product as a target cluster.

For example, the server may calculate an inner product between the user description feature and each object feature in the target cluster, sort all the object features in descending order of inner products, and use to-be-pushed objects corresponding to a preset quantity of object features that rank high as candidate push objects.

In the foregoing aspect, a manner of selecting the candidate push object from the to-be-pushed objects is described. The candidate push objects may be configured for determining the target push object to be pushed to the target user. In this manner, an object that is similar to an object interacted with the target user and that is interacted by a user having a similar orientation of interest may be selected, and the selected candidate push object may be configured for determining the target push object to be pushed to the target user. This increases a matching degree between the target push object and the target user, and reduces wastes of communication resources caused by push of an object with a low matching degree.

In some aspects, the interaction object information is interaction video information. The interaction video information includes information of at least one video having an interaction relationship with the target user. The to-be-pushed object is a to-be-pushed video. The candidate push object is a candidate push video. The target push object is a target push video. Alternatively, the interaction object information is interaction product information. The interaction product information includes information of at least one product having an interaction relationship with the target user. The to-be-pushed object is a to-be-pushed product. The candidate push object is a candidate push product. The target push object is a target push product.

The push object processing method provided in this aspect of this disclosure may be applied to a video push scenario. In the video push scenario, the object in this aspect of this disclosure may be replaced with a video.

During specific implementation, the server may obtain the interaction video information corresponding to the target user, and obtain a user description feature of the target user based on the interaction video information. The interaction video information includes information of at least one video having an interaction relationship with the target user. Interaction user information corresponding to each to-be-pushed video is obtained, and a video feature corresponding to a corresponding to-be-pushed video is determined based on the interaction user information. The interaction user information includes information of at least one user having an interaction relationship with the corresponding to-be-pushed video. The candidate push video is selected from to-be-pushed videos based on the user description feature and video features respectively corresponding to the to-be-pushed videos, and the candidate push video is configured for determining the target push video to be pushed to the target user.

In the video push scenario, for operations of obtaining the interaction video information, obtaining the user description feature of the target user, obtaining the interaction user information corresponding to each to-be-pushed video, determining the video feature corresponding to the to-be-pushed video, selecting the candidate push video, and the like, refer to descriptions in the foregoing aspects. Details are not described herein again in this aspect of this disclosure.

The push object processing method provided in this aspect of this disclosure may be applied to a product push scenario. In the product push scenario, the object in this aspect of this disclosure may be replaced with a product.

During specific implementation, the server may obtain the interaction product information corresponding to the target user, and obtain a user description feature of the target user based on the interaction product information. The interaction product information includes information of at least one product having an interaction relationship with the target user. Interaction user information corresponding to each to-be-pushed product is obtained, and a product feature corresponding to a corresponding to-be-pushed product is determined based on the interaction user information. The interaction user information includes information of at least one user having an interaction relationship with the corresponding to-be-pushed product. The candidate push product is selected from to-be-pushed products based on the user description feature and product features respectively corresponding to the to-be-pushed products, and the candidate push product is configured for determining the target push product to be pushed to the target user.

In the product push scenario, for operations of obtaining the interaction product information, obtaining the user description feature of the target user, obtaining the interaction user information corresponding to each to-be-pushed product, determining the product feature corresponding to the to-be-pushed product, selecting the candidate push product, and the like, refer to descriptions in the foregoing aspects. Details are not described herein again in this aspect of this disclosure.

In the foregoing aspect, a video push manner in the video push scenario and a product push manner in the product push scenario are provided. A video or a product pushed to the target user in this manner has a high matching degree with the target user. This improves user experience of the target user for the application and reduces traffic waste caused by push of an irrelevant video or product.

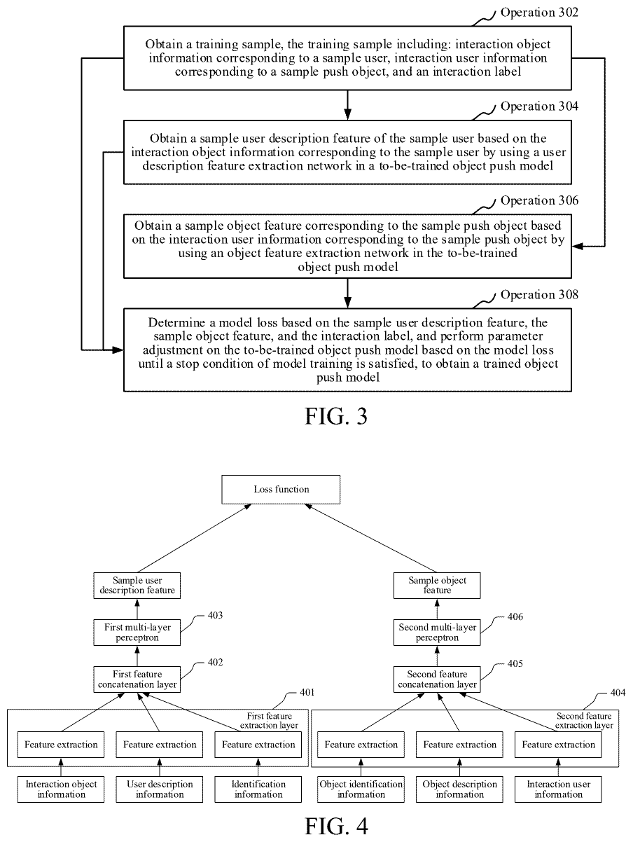

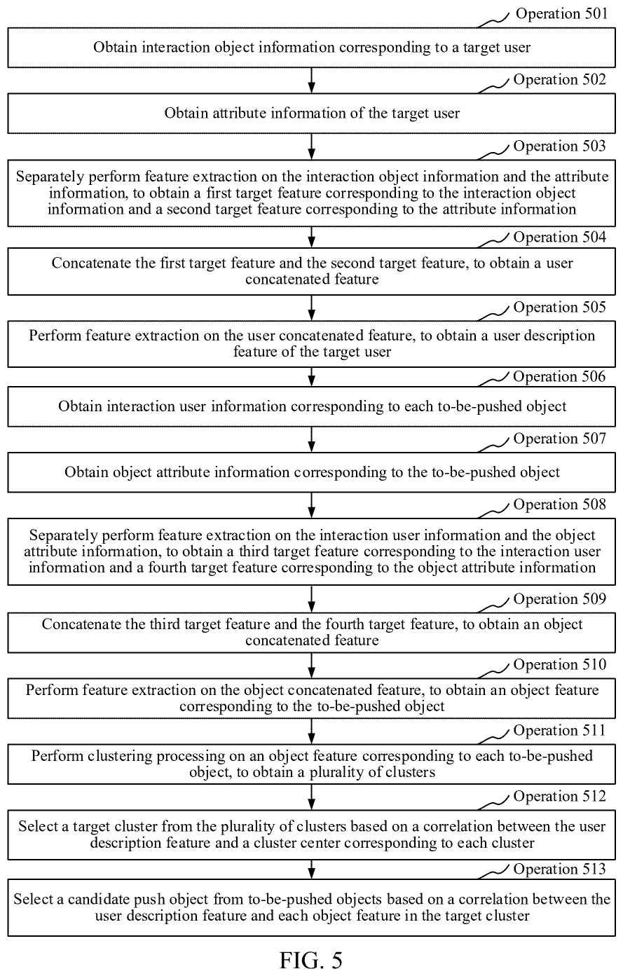

In some aspects, as shown in FIG. 3, a method for training an object push model is provided. An example in which the method is applied to a computer device is used for description. The computer device may be the terminal or the server in FIG. 1, or a system including the terminal and the server. The method includes the following operations.

Operation 302: Obtain a training sample, the training sample including: interaction object information corresponding to a sample user, interaction user information corresponding to a sample push object, and an interaction label. For example, a training sample is obtained. The training sample includes interaction object information corresponding to a sample user, interaction user information corresponding to a sample push object, and an interaction label.

The server stores a plurality of groups of historical data, and each group of historical data includes information such as a user, object identification information, and an interaction relationship. The server may obtain the training sample based on the historical data. For a generation process of the historical data, refer to descriptions in the foregoing aspects. Details are not described herein again in this aspect of this disclosure.

During specific implementation, the server may use a user in any group of historical data as the sample user. The server may search the plurality of stored groups of historical data for information of an object having an interaction relationship with the sample user, and sort the found information, to obtain the interaction object information corresponding to the sample user.

The sample user may be a unique identifier on an application. For example, the sample user may be identification information (user information, uin for short).

The interaction relationship may be a relationship indicated by an interaction operation performed by the sample user on a corresponding object on the application, and the sample user is a user with the user identifier of the sample user operating on the application. For example, when the interaction operation performed by the sample user is a tapping operation, the interaction relationship is a tapping relationship. When the interaction operation performed by the sample user is a forwarding operation, the interaction relationship is a forwarding relationship. When the interaction operation performed by the sample user is a collecting operation, the interaction relationship is a collecting relationship.

The information of the object having the interaction relationship with the sample user may be object attribute information. The object attribute information may include object identification information (an identity document, ID for short), object description information, and the like. The object description information may include an author tag, a title, a size of occupied space, and the like. This is not limited in this aspect of this disclosure.

The server may use an object corresponding to any object identification information in an object pool as the sample push object. The server may search the plurality of stored groups of historical data for users who have interaction relationships with the sample push object, and sort the found users, to obtain the interaction user information corresponding to the sample push object.

The server may determine the interaction label based on whether the sample user exists in the interaction user information corresponding to the sample push object.

During specific implementation, the server may search users that have performed the interaction operations on the sample push object for the sample user. If the sample user can be found, it is determined that the sample push object is a positive sample, and the interaction label is set to “interacted”, or is set to a preset value corresponding to “interacted”. If the sample user cannot be found, it is determined that the sample push object is a negative sample, and the interaction label is set to no interaction, or set to a preset value corresponding to no interaction.

Operation 304: Obtain, based on the interaction object information corresponding to the sample user, a sample user description feature of the sample user by using a user description feature extraction network in a to-be-trained object push model. For example, based on the interaction object information corresponding to the sample user, a sample user description feature of the sample user is obtained from a user description feature extraction network in a to-be-trained object push model.

The server may input the interaction object information corresponding to the sample user into the user description feature extraction network, and the user description feature extraction network performs feature extraction on the interaction object information, to obtain the sample user description feature of the sample user.

The server may further obtain attribute information of the sample user, and the server may input the interaction object information and the attribute information corresponding to the sample user into the user description feature extraction network, to obtain the sample user description feature of the sample user.

During specific implementation, the user description feature extraction network may obtain the sample user description feature in the following manner. Feature extraction is performed on the interaction object information corresponding to the sample user, to obtain a feature extraction result corresponding to the interaction object information, and feature extraction is performed on the attribute information of the sample user, to obtain a feature extraction result corresponding to the attribute information. The server may concatenate the feature extraction result corresponding to the interaction object information and the feature extraction result corresponding to the attribute information, to obtain a sample user concatenated feature, and perform feature extraction on the sample user concatenated feature again, to obtain the sample user description feature of the sample user.

During specific implementation, the user description feature extraction network includes a first feature extraction layer, a first feature concatenation layer, and a first multi-layer perceptron (MLP for short). The feature extraction may be separately performed on the interaction object information and the attribute information through the first feature extraction layer, to obtain the feature extraction result corresponding to the interaction object information and the feature extraction result corresponding to the attribute information. The feature extraction result corresponding to the interaction object information and the feature extraction result corresponding to the attribute information may be concatenated through the first feature concatenation layer, to obtain the sample user concatenated feature. The feature extraction may be performed on the sample user concatenated feature by using the first MLP, to obtain the sample user description feature of the sample user.

Operation 306: Obtain, based on the interaction user information corresponding to the sample push object, a sample object feature corresponding to the sample push object by using an object feature extraction network in the to-be-trained object push model. For example, based on the interaction user information corresponding to the sample push object, a sample object feature corresponding to the sample push object is obtained from an object feature extraction network in the to-be-trained object push model.

The server may input the interaction user information corresponding to the sample push object into the object feature extraction network, and the object feature extraction network performs feature extraction on the interaction user information, to obtain the sample object feature corresponding to the sample push object.

The server may further obtain object attribute information corresponding to the sample push object, and the server may input the interaction user information and the object attribute information corresponding to the sample push object into the object feature extraction network, to obtain the sample object feature corresponding to the sample push object.

During specific implementation, the object feature extraction network may obtain the sample object feature in the following manner. Feature extraction is performed on the interaction user information corresponding to the sample push object, to obtain a feature extraction result corresponding to the interaction user information. Feature extraction is performed on the object attribute information corresponding to the sample push object, to obtain a feature extraction result corresponding to the object attribute information. The server may concatenate the feature extraction result corresponding to the interaction user information and the feature extraction result corresponding to the object attribute information, to obtain a sample object concatenated feature, and perform feature extraction on the sample object concatenated feature again, to obtain the sample object feature corresponding to the sample push object.

During specific implementation, the object feature extraction network includes a second feature extraction layer, a second feature concatenation layer, and a second multi-layer perceptron (MLP for short). The feature extraction may be separately performed on the interaction user information and the object attribute information through the second feature extraction layer, to obtain the feature extraction result corresponding to the interaction user information and the feature extraction result corresponding to the object attribute information. The feature extraction result corresponding to the interaction user information and the feature extraction result corresponding to the object attribute information may be concatenated through the second feature concatenation layer, to obtain the sample object concatenated feature. The feature extraction may be performed on the sample object concatenated feature by using the second MLP, to obtain the sample object feature corresponding to the sample push object.

For example, refer to FIG. 4. The user description feature extraction network includes a first feature extraction layer 401, a first feature concatenation layer 402, and a first multi-layer perceptron 403. The object feature extraction network includes a second feature extraction layer 404, a second feature concatenation layer 405, and a second multi-layer perceptron 406. The server may input the interaction object information corresponding to the sample user, the user description information corresponding to the sample user, and the identification information corresponding to the sample user into the first feature extraction layer 401. The first feature extraction layer 401 outputs the feature extraction result of the interaction object information, a feature extraction result of the user description information, and a feature extraction result of the identification information. The first feature concatenation layer 402 concatenates the feature extraction result of the interaction object information, the feature extraction result of the user description information, and the feature extraction result of the identification information, and outputs the sample user concatenated feature. The first multi-layer perceptron 403 performs feature extraction on the sample user concatenated feature again, and outputs the sample user description feature of the sample user. The server may input the interaction user information corresponding to the sample push object, the object description information corresponding to the sample push object, and object identification information corresponding to the sample push object into the second feature extraction layer 404. The second feature extraction layer 404 outputs the feature extraction result of the interaction user information, a feature extraction result of the object description information, and a feature extraction result of the object identification information. The second feature concatenation layer 405 concatenates the feature extraction result of the interaction user information, the feature extraction result of the object description information, and the feature extraction result of the object identifier information, and outputs the sample object concatenated feature. The second multi-layer perceptron 406 performs feature extraction on the sample object concatenated feature again, and outputs the sample object feature corresponding to the sample push object.

Operation 308: Determine a model loss based on the sample user description feature, the sample object feature, and the interaction label, and perform parameter adjustment on the to-be-trained object push model based on the model loss until a stop condition of model training is satisfied, to obtain a trained object push model. For example, a model loss is determined based on the sample user description feature, the sample object feature, and the interaction label. Parameters of the to-be-trained object push model are adjusted based on the model loss until a stop condition of model training is satisfied to obtain a trained object push model that is configured to select a candidate push object from a plurality of to-be-pushed objects for a target user.

After obtaining the sample user description feature and the sample object feature, the server may calculate the model loss based on the sample user description feature, the sample object feature, and the interaction label by using a preset loss function.

During specific implementation, any loss function configured for resolving a classification problem may be used as the preset loss function. For example, a cross-entropy loss function may be used as the preset loss function.

After obtaining the model loss, the server may determine, based on the model loss, whether a current object push model satisfies the stop condition of the model training. In a case that the current object push model satisfies the stop condition of the model training, the current object push model is used as the trained object push model. In a case that the current object push model does not satisfy the stop condition of the model training, the parameter adjustment is performed on the to-be-trained object push model based on the model loss, and the foregoing training operations continue to be performed until the stop condition of the model training is satisfied, to obtain the trained object push model.

The trained object push model is configured to select a candidate push object from to-be-pushed objects, and the candidate push object is configured for determining a target to-be-pushed object.

During specific implementation, interaction object information corresponding to a target user may be obtained, and a user description feature of the target user is obtained based on the interaction object information by using the trained object push model. Interaction user information corresponding to each to-be-pushed object is obtained, and an object feature corresponding to a corresponding to-be-pushed object is determined based on the interaction user information by using the trained object push model. The candidate push object is selected from the to-be-pushed objects based on the user description feature and object features respectively corresponding to the to-be-pushed objects, and the target push object to be pushed to the target user is determined based on the candidate push object. For a detailed process, refer to descriptions in the foregoing aspects. Details are not described herein again in this aspect of this disclosure.

In the foregoing aspect, the training sample is obtained. The training sample includes the interaction object information corresponding to the sample user, the interaction user information corresponding to the sample push object, and the interaction label. The sample user description feature of the sample user is obtained based on the interaction object information corresponding to the sample user by using the user description feature extraction network in the to-be-trained object push model. The sample object feature corresponding to the sample push object is obtained based on the interaction user information corresponding to the sample push object by using the object feature extraction network in the to-be-trained object push model. The model loss is determined based on the sample user description feature, the sample object feature, and the interaction label, and the parameter adjustment is performed on the to-be-trained object push model based on the model loss until the stop condition of the model training is satisfied, to obtain the trained object push model. In a training process, on a sample user side, the interaction object information corresponding to the sample user is inputted, and on a sample push object side, the interaction user information corresponding to the sample push object is inputted. The interaction object information and the interaction user information form a dual behavior sequence, so that the model can learn a similarity of interaction habits between users and a similarity between objects in which the users are interested, thereby improving an object matching effect of the object push model.

In some aspects, obtaining the training sample includes: selecting a user in various manners from historical interaction users as the sample user, and obtaining the interaction object information corresponding to the sample user; selecting an object in various manners from an object pool as the sample push object, and obtaining the interaction user information corresponding to the sample push object; determining the interaction label based on an interaction status between the sample user and the sample push object; and determining the training sample based on the interaction object information corresponding to the sample user, the interaction user information corresponding to the sample push object, and the interaction label.

After each user performs an interaction operation on an object on the application, the server may record information such as a user identifier used by the user on the application, object identification information of the object, and an interaction relationship indicated by the interaction operation, to generate a group of historical data. As interaction operations are continuously performed, the server may accumulate a plurality of groups of historical data. A user in each piece of historical data may be referred to as a historical interaction user.

During specific implementation, the server may select a user in various manners from historical interaction users as the sample user. After determining the sample user, the server may search the historical data for information of an object having an interaction relationship with the sample user, and sort the found information, to obtain the interaction object information corresponding to the sample user.

The object pool is configured in the server, the object pool may be configured for storing object identification information corresponding to an object uploaded in a latest preset time period, and the server may use an object corresponding to any object identification information in the object pool as the sample push object. The server may search the plurality of stored groups of historical data for users who have interaction relationships with the sample push object, and sort the found users, to obtain the interaction user information corresponding to the sample push object.

The server may search users that have performed the interaction operations on the sample push object for the sample user. If the sample user can be found, the interaction label is set as “interacted”, or is set as a preset value corresponding to “interacted”. If the sample user cannot be found, the interaction label is set to no interaction, or is set to a preset value corresponding to no interaction.

The server may use the interaction object information corresponding to the sample user, the interaction user information corresponding to the sample push object, and the interaction label as a training sample. The server performs the foregoing operations for a plurality of times, and may obtain a plurality of training samples, to form a sample set.

In the foregoing aspect, a process of obtaining the training sample is described. The interaction user information corresponding to the sample push object is also used as a part of the training sample, so that the model can learn a similarity of interaction habits between users, thereby improving an object matching effect of the object push model.

In some aspects, the method for training an object push model provided in this aspect of this disclosure may further include: obtaining an object uploaded in a first preset time period before a current date; and determining the object pool based on the uploaded object.

The first preset time period may be flexibly set according to an actual situation. The first preset time period may be N days. For example, N may be 30. This is not limited in this aspect of this disclosure.

The server may obtain, at a preset time point each day, the object uploaded in the first preset time period before the current date, and determine the object pool based on the uploaded object. The object may be audio, a video, or the like.

During specific implementation, after obtaining the object uploaded in the first preset time period before the current date, the server may construct the object pool based on object identification information corresponding to each uploaded object.

An example is provided below.

The server may obtain, at 8:00 a.m. every day, a video uploaded in 30 days before the current date. Assuming that object identification information of obtained uploaded videos is respectively: ID 1, ID 2, ID 3, ID 4, and ID 5, a set formed by the ID 1, the ID 2, the ID 3, the ID 4, and the ID 5 may be used as a video pool.

In the foregoing aspect, the object uploaded in the first preset time period before the current date is obtained. The object pool is determined based on the uploaded object. Because the object has time validity, when the candidate push object is determined, the candidate push object is usually selected from objects uploaded recently. Compared with a manner in which all objects uploaded historically are placed into an object pool, the foregoing manner of determining the object pool reduces computing resource consumption while ensuring time validity of the push object.

In some aspects, the method for training an object push model provided in this aspect of this disclosure may further include: displaying, after an access request of a first user for a first object is received, the first object, and obtaining interaction information of the first user with respect to the first object; and updating, based on the interaction information in a case that the first object belongs to the object pool and the first user belongs to a seed user pool, interaction user information corresponding to the first object. A user in the user pool may be represented by a user identifier.

In a process in which the first user uses the application, the first user may perform a trigger operation on the first object. After detecting the trigger operation, the application may generate an access request for the first object. The access request may carry the first user. The application may send the access request to the server, and the server uses the access request as the access request of the first user for the first object.

During specific implementation, the trigger operation may be a tapping operation, a double-tapping operation, a slide operation, or the like. This is not limited in this aspect of this disclosure.

After receiving the access request for the first object, the server may send the first object to the application. The application displays the first object for the first user to view. In a process of viewing the first object, the first user performs a corresponding interaction operation on the first object based on a degree of interest of the first object. After detecting the interaction operation, the application sends an interaction message to the server. The interaction message may carry the first user, an interaction relationship, and the like. After receiving the interaction message, the server uses the interaction message as the interaction information of the first user with respect to the first object.

After obtaining the interaction information, the server may determine whether the first object belongs to the object pool and determine whether the first user belongs to the seed user pool, and update, based on the interaction information in a case that the first object belongs to the object pool and the first user belongs to the seed user pool, the interaction user information corresponding to the first object.

During specific implementation, the server may obtain object identification information corresponding to the first object, and determine whether the object identification information corresponding to the first object is in the object identification information included in the object pool. If the object identification information corresponding to the first object is in the object identification information included in the object pool, the server determines that the first object belongs to the object pool.

During specific implementation, the server may determine whether the first user is in identification information included in the seed user pool. If the first user is in the identification information included in the seed user pool, the server determines that the first user belongs to the seed user pool.

During specific implementation, the interaction user information corresponding to the first object is a sequence formed by a user having an interaction relationship with the first object. Whether the interaction relationship in the interaction information matches the interaction relationship in the interaction user information may be determined. If the interaction relationship in the interaction information matches the interaction relationship in the interaction user information, the first user is added to the interaction user information. If the interaction relationship in the interaction information does not match the interaction relationship in the interaction user information, no adding processing is performed.

For example, the interaction relationship in the interaction user information corresponding to the first object may be preset. Assuming that the interaction relationships in the interaction user information corresponding to the first object are: a tapping relationship, a collecting relationship, and a forwarding relationship, the server may determine whether the interaction relationship in the interaction information is one of the foregoing three relationships. If the interaction relationship in the interaction information is one of the foregoing three relationships, it is determined that the interaction relationship in the interaction information matches the interaction relationship in the interaction user information. If the interaction relationship in the interaction information is not one of the foregoing three relationships, it is determined that the interaction relationship in the interaction information does not match the interaction relationship in the interaction user information.

In the foregoing aspect, a specific manner of updating the interaction user information is described. In this manner, only the interaction user information of the object in the object pool is updated, and there is no need to update all historically uploaded objects, so that waste of update processing resources is reduced. In addition, in this manner, when a current user belongs to the seed user pool, the current user is added to the interaction user information. This ensures that the interaction user information only includes highly active users, and improves a convergence speed of a model training process.

In some aspects, the method for training an object push model provided in this aspect of this disclosure may further include: determining, for each user in the interaction user information corresponding to the first object, whether a targeted user belongs to the seed user pool, and deleting, in a case that the targeted user does not belong to the seed user pool, the targeted user from the interaction user information corresponding to the first object.

For each user in the interaction user information corresponding to the first object, the server may determine whether the user is included in the seed user pool. If the user is in the seed user pool, the server determines that the user belongs to the seed user pool. If the user is not in the seed user pool, the server determines that the user does not belong to the seed user pool.

For each user in the interaction user information corresponding to the first object, in a case that the server determines that the user does not belong to the seed user pool, the server may delete the user from the interaction user information corresponding to the first object. In a case that the server determines that the user belongs to the seed user pool, the server may retain the user.

In the foregoing aspect, for each user in the interaction user information corresponding to the first object, whether the targeted user belongs to the seed user pool is determined, and the targeted user is deleted from the interaction user information corresponding to the first object in a case that the targeted user does not belong to the seed user pool. This ensures that the interaction user information only includes highly active users, and improves a convergence speed of a model training process.

In some aspects, the method for training an object push model provided in this aspect of this disclosure may further include: obtaining an interaction user who performs an interaction operation in a second preset time period before a current date; and determining the seed user pool based on the interaction user.

The second preset time period may be flexibly set based on an actual situation. The second preset time period may be N days. For example, N may be 30. This is not limited in this aspect of this disclosure.

The server may obtain, at a preset time point each day, the interaction user who performs the interaction operation in the second preset time period before the current date. The seed user pool is determined based on the interaction user.

During specific implementation, the server may specify the interaction operation in advance. For example, the interaction operation may be a tapping operation, a like operation, or a forwarding operation.

During specific implementation, after obtaining the interaction user who performs the interaction operation in the second preset time period before the current date, the server may construct the seed user pool based on identification information corresponding to the interaction user.

An example is provided below.

The server may obtain, at 10:00 a.m. every day, an interaction user who performs an interaction operation in 30 days before the current date. Assuming that object identification information of obtained interaction users is respectively: uin 1, uin 2, uin 3, uin 4, and uin 5, a set formed by the uin 1, the uin 2, the uin 3, the uin 4, and the uin 5 may be used as a seed user pool.

In the foregoing aspect, the interaction user who performs the interaction operation in the second preset time period before the current date is obtained. The seed user pool is determined based on the interaction user. The seed user pool may be configured for filtering a low activity user. This ensures that the interaction user information only includes highly active users, and improves a convergence speed of a model training process.

In some aspects, a push object processing method is provided. An example in which the method is performed by a computer device is used for description. The method includes the following operations.

Operation 501: Obtain interaction object information corresponding to a target user. For example, interaction object information corresponding to a target user is obtained. The interaction object information includes information of at least one object having an interaction relationship with the target user. A user description feature of the target user is determined based on the interaction object information.

The interaction object information includes information of at least one object having an interaction relationship with the target user.

Operation 502: Obtain attribute information of the target user. For example, attribute information of the target user is obtained. The attribute information includes at least one of user description information or identification information.

The attribute information includes at least one of user description information or identification information.

Operation 503: Separately perform feature extraction on the interaction object information and the attribute information, to obtain a first target feature corresponding to the interaction object information and a second target feature corresponding to the attribute information. For example, feature extraction on the interaction object information and the attribute information are separately performed to obtain a first target feature corresponding to the interaction object information and a second target feature corresponding to the attribute information.

Operation 504: Concatenate the first target feature and the second target feature, to obtain a user concatenated feature. For example, the first target feature and the second target feature are concatenated to obtain a user concatenated feature.

Operation 505: Perform feature extraction on the user concatenated feature, to obtain a user description feature of the target user. For example, the user description feature of the target user is extracted by performing feature extraction on the user concatenated feature.

Operation 506: Obtain interaction user information corresponding to each to-be-pushed object. For example, interaction user information corresponding to a plurality of to-be-pushed objects is obtained. The interaction user information of each of the plurality of to-be-pushed objects includes information of at least one user having an interaction relationship with the respective to-be-pushed objects. Based on the interaction user information, object features corresponding to the plurality of to-be-pushed objects are determined.

The interaction user information includes information of at least one user having an interaction relationship with a corresponding to-be-pushed object.

Operation 507: Obtain object attribute information corresponding to the to-be-pushed object. For example, object attribute information corresponding to the respective to-be-pushed object is obtained. The object attribute information includes at least one of object description information or object identification information.

The object attribute information includes at least one of object description information or object identification information.

Operation 508: Separately perform feature extraction on the interaction user information and the object attribute information, to obtain a third target feature corresponding to the interaction user information and a fourth target feature corresponding to the object attribute information. For example, feature extraction is separately performed on the interaction user information of the respective to-be-pushed object and the object attribute information of the respective to-be-pushed object to obtain a third target feature corresponding to the interaction user information of the respective to-be-pushed object and a fourth target feature corresponding to the object attribute information of the respective to-be-pushed object.

Operation 509: Concatenate the third target feature and the fourth target feature, to obtain an object concatenated feature. For example, the third target feature and the fourth target feature are concatenated to obtain an object concatenated feature of the respective to-be-pushed object.

Operation 510: Perform feature extraction on the object concatenated feature, to obtain an object feature corresponding to the to-be-pushed object. For example, an object feature corresponding to the respective to-be-pushed object is extracted by performing feature extraction on the object concatenated feature.

Operation 511: Perform clustering processing on an object feature corresponding to each to-be-pushed object, to obtain a plurality of clusters. For example, clustering processing is performed on the object features corresponding to the plurality of to-be-pushed objects to obtain a plurality of clusters. Each cluster is associated with at least one to-be-pushed object.

Operation 512: Select a target cluster from the plurality of clusters based on a correlation between the user description feature and a cluster center corresponding to each cluster. For example, a target cluster is selected from the plurality of clusters based on a correlation between the user description feature and a cluster center corresponding to each cluster.

Operation 513: Select a candidate push object from to-be-pushed objects based on a correlation between the user description feature and each object feature in the target cluster. For example, the candidate push object is selected from the to-be-pushed objects associated with the target cluster based on a correlation between the user description feature and each object feature in the target cluster.

In the foregoing aspect, the interaction object information corresponding to the target user is obtained, and the user description feature of the target user is obtained based on the interaction object information. The interaction object information includes information of at least one object having an interaction relationship with the target user. In addition, the interaction user information corresponding to each to-be-pushed object is obtained, and the object feature corresponding to the corresponding to-be-pushed object is determined based on the interaction user information. The interaction user information includes the information of the at least one user having the interaction relationship with the corresponding to-be-pushed object. The interaction object information and the interaction user information form a dual behavior sequence. The candidate push object is selected from to-be-pushed objects based on the user description feature and object features respectively corresponding to the to-be-pushed objects. In a process of selecting the candidate push object, objects having interaction relationships with the target user are considered, and users who perform interaction operations on the to-be-pushed object are considered. In this manner, an object that is similar to an object interacted with the target user and that is interacted by a user having a similar orientation of interest may be selected, and the selected candidate push object may be configured for determining the target push object to be pushed to the target user. This increases a matching degree between the target push object and the target user, and reduces wastes of communication resources caused by push of an object with a low matching degree.

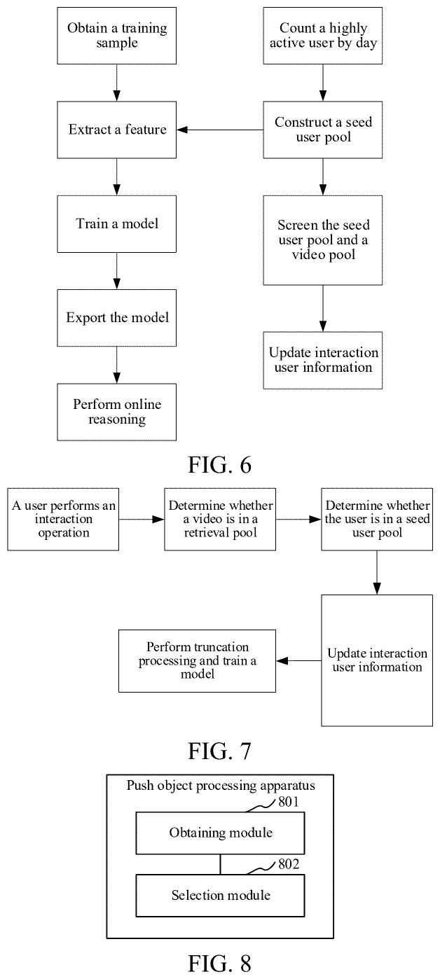

In some aspects, the push object processing method provided in this aspect of this disclosure may be applied to a video push scenario. Refer to FIG. 6. A server may first obtain a training sample based on historical data, perform feature extraction on interaction video information and interaction user information in the training sample, to obtain a sample user description feature and a sample video feature, perform model training based on the sample user description feature and the sample video feature, to obtain a trained video push model, and may export the video push model, perform online reasoning by using the video push model, and select a candidate push video from to-be-pushed videos. Interaction users who perform interaction operations in latest preset quantity of days may be counted by using a day as a statistical unit. These interaction users are used as highly active users, and a seed user pool is constructed by using these highly active users. When a user performs an interaction operation on a video on an application, the seed user pool may be screened for the user, a video pool may be screened for video identification information corresponding to the video, and interaction user information corresponding to the video is updated in a case that the user belongs to the seed user pool and the video belongs to the video pool.

During specific implementation, refer to FIG. 7. The push object processing method provided in this aspect of this disclosure may be applied to a retrieval scenario of video push. When a user performs an interaction operation on a video on the application, the server may determine whether the video is in a retrieval pool. If the video is in the retrieval pool, the server further determines whether the user is in the seed user pool, and if the user is in the seed user pool, the server updates interaction user information corresponding to the video. In a training process, based on an input length of interaction user information corresponding to a to-be-trained video push model, truncation processing may be performed on the interaction user information corresponding to the video, to obtain a length adapted to the to-be-trained video push model, and model training is performed based on interaction user information obtained through the truncation processing.

The foregoing provided application scenarios are merely used for describing the push object processing method in this disclosure, and application of the push object processing method provided in this disclosure is not limited to the foregoing provided application scenarios. For example, the method may be further applied to a product push scenario or a news push scenario. This is not limited in this aspect of this disclosure.

Although the operations in the flowcharts according to each aspect are displayed in sequence based on indication of arrows, the operations are not necessarily performed in sequence based on a sequence indicated by the arrows. Unless otherwise explicitly specified in this disclosure, execution of the operations is not strictly limited, and the operations may be performed in other sequences. In addition, at least some operations in the flowcharts of the foregoing aspects may include a plurality of operations or a plurality of stages, and these operations or stages are not necessarily performed at a same time instant, and may be performed at different time instants. These operations or stages are not necessarily performed in sequence, and the operations or stages may be performed alternately with at least some of other operations, operations or stages of other operations.

Based on the same inventive concept, an aspect of this disclosure further provides an apparatus for implementing the foregoing push object processing method. An implementation for resolving problems provided in the apparatus is similar to the implementation described in the foregoing method. Therefore, for specific limitations in one or more push object processing apparatus aspects provided below, refer to the foregoing limitations on the push object processing method. Details are not described herein again.

In an aspect, as shown in FIG. 8, a push object processing apparatus is provided, including:

an obtaining module 801, configured to obtain interaction object information corresponding to a target user, and obtain a user description feature of the target user based on the interaction object information, the interaction object information including information of at least one object having an interaction relationship with the target user;

the obtaining module 801 being configured to obtain interaction user information corresponding to each to-be-pushed object, and determine, based on the interaction user information, an object feature corresponding to a corresponding to-be-pushed object, the interaction user information including information of at least one user having an interaction relationship with the corresponding to-be-pushed object; and

a selection module 802, configured to select a candidate push object from to-be-pushed objects based on the user description feature and object features respectively corresponding to the to-be-pushed objects, the candidate push object being configured for determining a target push object to be pushed to the target user.

In some aspects, obtaining the user description feature of the target user based on the interaction object information and determining, based on the interaction user information, the object feature corresponding to the corresponding to-be-pushed object are both implemented by using a trained object push model.

In some aspects, the obtaining module 801 is specifically configured to: determine the user description feature of the target user based on the interaction object information by using a user description feature extraction network in the trained object push model; and determine, based on the interaction user information by using an object feature extraction network in the trained object push model, the object feature corresponding to the corresponding to-be-pushed object.

In some aspects, the obtaining module 801 is specifically configured to: obtain attribute information of the target user, the attribute information including at least one of user description information or identification information; separately perform feature extraction on the interaction object information and the attribute information, to obtain a first target feature corresponding to the interaction object information and a second target feature corresponding to the attribute information; concatenate the first target feature and the second target feature, to obtain a user concatenated feature; and perform feature extraction on the user concatenated feature, to obtain the user description feature of the target user.

In some aspects, the obtaining module 801 is specifically configured to: obtain object attribute information corresponding to the to-be-pushed object, the object attribute information including at least one of object description information or object identification information; separately perform feature extraction on the interaction user information and the object attribute information, to obtain a third target feature corresponding to the interaction user information and a fourth target feature corresponding to the object attribute information; concatenate the third target feature and the fourth target feature, to obtain an object concatenated feature; and perform feature extraction on the object concatenated feature, to obtain the object feature corresponding to the to-be-pushed object.

In some aspects, the obtaining module 801 is further configured to: obtain a training sample, the training sample including: interaction object information corresponding to a sample user, interaction user information corresponding to a sample push object, and an interaction label; obtain, based on the interaction object information corresponding to the sample user, a sample user description feature of the sample user by using a user description feature extraction network in a to-be-trained object push model; obtain, based on the interaction user information corresponding to the sample push object, a sample object feature corresponding to the sample push object by using an object feature extraction network in the to-be-trained object push model; and determine a model loss based on the sample user description feature, the sample object feature, and the interaction label, and perform parameter adjustment on the to-be-trained object push model based on the model loss until a stop condition of model training is satisfied, to obtain the trained object push model.

In some aspects, the selection module 802 is specifically configured to: perform clustering processing on the object feature corresponding to each to-be-pushed object, to obtain a plurality of clusters; select a target cluster from the plurality of clusters based on a correlation between the user description feature and a cluster center corresponding to each cluster; and select the candidate push object from the to-be-pushed objects based on a correlation between the user description feature and each object feature in the target cluster.

In some aspects, the interaction object information is interaction video information. The interaction video information includes information of at least one video having an interaction relationship with the target user. The to-be-pushed object is a to-be-pushed video. The object feature is a video feature. The candidate push object is a candidate push video. The target push object is a target push video. Alternatively, the interaction object information is interaction product information. The interaction product information includes information of at least one product having an interaction relationship with the target user. The to-be-pushed object is a to-be-pushed product. The object feature is a product feature. The candidate push object is a candidate push product. The target push object is a target push product.

All or some of the modules in the push object processing apparatus may be implemented by software, hardware, and a combination thereof. The foregoing modules may be built in or independent of a processor of a computer device in the form of hardware, or may be stored in a memory of the computer device in the form of software, for the processor to invoke to execute operations corresponding to the foregoing modules.

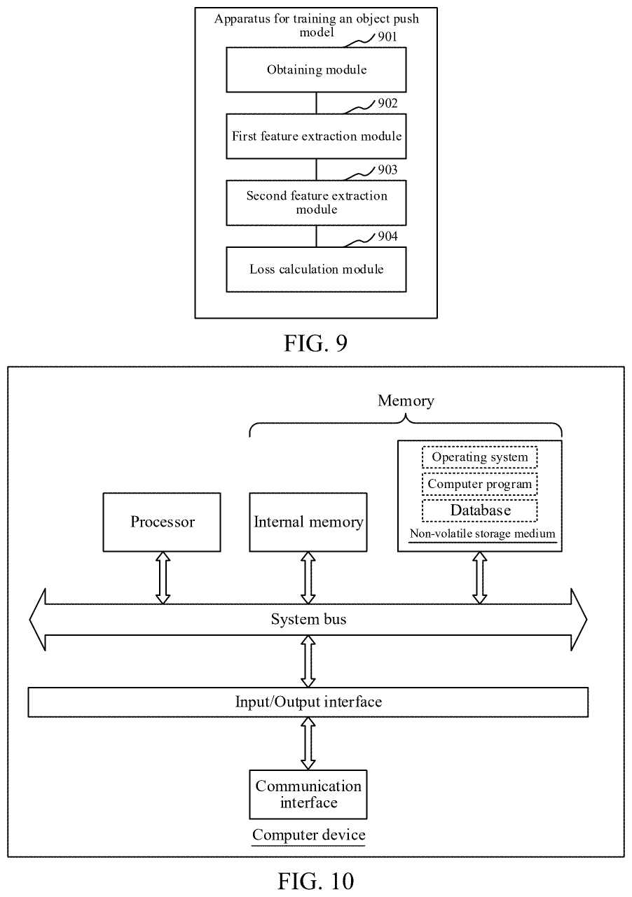

In an aspect, as shown in FIG. 9, an apparatus for training an object push model is provided, including:

an obtaining module 901, configured to obtain a training sample, the training sample including: interaction object information corresponding to a sample user, interaction user information corresponding to a sample push object, and an interaction label;

a first feature extraction module 902, configured to obtain, based on the interaction object information corresponding to the sample user, a sample user description feature of the sample user by using a user description feature extraction network in a to-be-trained object push model;

a second feature extraction module 903, configured to obtain, based on the interaction user information corresponding to the sample push object, a sample object feature corresponding to the sample push object by using an object feature extraction network in the to-be-trained object push model; and

a loss calculation module 904, configured to determine a model loss based on the sample user description feature, the sample object feature, and the interaction label, and perform parameter adjustment on the to-be-trained object push model based on the model loss until a stop condition of model training is satisfied, to obtain a trained object push model.

The trained object push model is configured to select a candidate push object from to-be-pushed objects, and the candidate push object is configured for determining a target to-be-pushed object.

In some aspects, the obtaining module 901 is specifically configured to: select a user in various manners from historical interaction users as the sample user, and obtain the interaction object information corresponding to the sample user; select an object in various manners from an object pool as the sample push object, and obtain the interaction user information corresponding to the sample push object; determine the interaction label based on an interaction status between the sample user and the sample push object; and determine the training sample based on the interaction object information corresponding to the sample user, the interaction user information corresponding to the sample push object, and the interaction label.

In some aspects, the apparatus for training an object push model further includes a processing module, configured to: obtain an object uploaded in a first preset time period before a current date; and determine the object pool based on the uploaded object.

In some aspects, the processing module is further configured to: display, after an access request of a first user for a first object is received, the first object, and obtain interaction information of the first user with respect to the first object; and update, based on the interaction information in a case that the first object belongs to the object pool and the first user belongs to a seed user pool, interaction user information corresponding to the first object.

In some aspects, the processing module is further configured to: determine, for each user in the interaction user information corresponding to the first object, whether a targeted user belongs to the seed user pool, and delete, in a case that the targeted user does not belong to the seed user pool, the targeted user from the interaction user information corresponding to the first object.

In some aspects, the processing module is further configured to: obtain an interaction user who performs an interaction operation in a second preset time period before the current date; and determine the seed user pool based on the interaction user.

All or some of the modules in the apparatus for training an object push model may be implemented by software, hardware, and a combination thereof. The foregoing modules may be built in or independent of a processor of a computer device in the form of hardware, or may be stored in a memory of the computer device in the form of software, for the processor to invoke to execute operations corresponding to the foregoing modules.

In an aspect, a computer device is provided. The computer device may be a server or a terminal, and an internal structure diagram of the computer device may be shown in FIG. 10. The computer device includes processing circuitry, such as a processor, a memory, an input/output (I/O for short) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium has an operating system, a computer program, and a database stored thereon. The inner memory provides an operating environment for the operating system and the computer program in the non-volatile storage medium. The database of the computer device is configured for storing interaction object information, interaction user information, and the like. The input/output interface of the computer device is configured to exchange information between the processor and an external device. The communication interface of the computer device is configured to connect and communicate with an external terminal through a network. The computer program, when executed by the processor, implement a push object processing method or a method for training an object push model.

A person skilled in the art may understand that, the structure shown in FIG. 10 is merely a block diagram of a partial structure related to a solution in this disclosure, and does not constitute a limitation to the computer device to which the solution in this disclosure is applied. Specifically, the computer device may include more components or fewer components than those shown in the figure, or some components may be combined, or a different component deployment may be used.

In an aspect, a computer device is further provided, including a memory and a processor. The memory has a computer program stored therein. The processor, when executing the computer program, implements the operations in the foregoing method aspects.

In an aspect, a computer-readable storage medium such as a non-transitory computer-readable storage medium is provided, having a computer program stored thereon. The computer program, when executed by a processor, implements the operations in the foregoing method aspects.

In an aspect, a computer program product is provided, including a computer program. The computer program, when executed by a processor, implements the operations in the foregoing method aspects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A person of ordinary skill in the art may understand that all or some of procedures of the method in the foregoing aspects may be implemented by a computer program instructing relevant hardware. The computer program may be stored in a non-volatile computer-readable storage medium. When the computer program is executed, the procedures of the foregoing method aspects may be implemented. References to the memory, the database, or other medium used in the aspects provided in this disclosure may all include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a grapheme memory, and the like. The volatile memory may include a random access memory (RAM), an external cache memory, or the like. As an illustration and not a limitation, the RAM may be in various forms, for example, a static random access memory (SRAM) or a dynamic random access memory (DRAM). The database in aspects provided in this disclosure may include at least one of a relational database or a non-relational database. The non-relational database may include a blockchain-based distributed database and the like, which is not limited thereto. The processors in aspects of this disclosure may be a general-purpose processor, a central processing unit, a graphics processing unit, a digital signal processor, a programmable logic device, a data processing logic device based on quantum computing, and the like, which is not limited thereto.

Technical features of the foregoing aspects may be combined in various manners. To make description concise, not all possible combinations of the technical features in the foregoing aspects are described. However, the combinations of these technical features shall be considered as falling within the scope recorded by this specification provided that no conflict exists.

The foregoing aspects only describe several implementations of this disclosure, which are described specifically and in detail, but cannot be construed as a limitation to the patent scope of this disclosure. For a person of ordinary skill in the art, several transformations and improvements can be made without departing from the idea of this disclosure. These transformations and improvements belong to the protection scope of this disclosure.

What is claimed is:

1. A push object processing method, comprising:
obtaining interaction object information corresponding to a target user, the interaction object information including information of at least one object having an interaction relationship with the target user;
determining a user description feature of the target user based on the interaction object information;
obtaining interaction user information corresponding to a plurality of to-be-pushed objects, the interaction user information of each of the plurality of to-be-pushed objects including information of at least one user having an interaction relationship with the respective to-be-pushed objects;
determining, based on the interaction user information, object features corresponding to the plurality of to-be-pushed objects; and
selecting, by processing circuitry, a candidate push object from the plurality of to-be-pushed objects based on the user description feature and the object features.

2. The method according to claim 1, wherein the determining the user description feature of the target user comprises:
inputting the interaction object information in a trained object push model, the trained object push model including a user description feature extraction network configured to extract the user description feature from the interaction object information; and
obtaining the user description feature of the target user from the trained object push model.

3. The method according to claim 2, wherein the determining, based on the interaction user information, the object features comprises:
inputting the interaction user information in an object feature extraction network in the trained object push model; and
obtaining the object features from the object feature extraction network.

4. The method according to claim 3, further comprising:
obtaining attribute information of the target user, the attribute information including at least one of user description information or identification information;
separately performing feature extraction on the interaction object information and the attribute information to obtain a first target feature corresponding to the interaction object information and a second target feature corresponding to the attribute information;
concatenating the first target feature and the second target feature to obtain a user concatenated feature; and
extracting the user description feature of the target user by performing feature extraction on the user concatenated feature.

5. The method according to claim 3, further comprising:
for each to-be-pushed object of the plurality of to-be-pushed objects:
obtaining object attribute information corresponding to the respective to-be-pushed object, the object attribute information including at least one of object description information or object identification information;
separately performing feature extraction on the interaction user information of the respective to-be-pushed object and the object attribute information of the respective to-be-pushed object, to obtain a third target feature corresponding to the interaction user information of the respective to-be-pushed object and a fourth target feature corresponding to the object attribute information of the respective to-be-pushed object;
concatenating the third target feature and the fourth target feature to obtain an object concatenated feature of the respective to-be-pushed object; and
extracting an object feature corresponding to the respective to-be-pushed object by performing feature extraction on the object concatenated feature.

6. The method according to claim 5, wherein the trained object push model is obtained by:
obtaining a training sample including: (i) interaction object information corresponding to a sample user, (ii) interaction user information corresponding to a sample push object, and (iii) an interaction label;
obtaining a sample user description feature of the sample user from a user description feature extraction network in a to-be-trained object push model based on the interaction object information corresponding to the sample user;
obtaining a sample object feature corresponding to the sample push object from an object feature extraction network in the to-be-trained object push model based on the interaction user information corresponding to the sample push object;
determining a model loss based on the sample user description feature, the sample object feature, and the interaction label; and
adjusting parameters of the to-be-trained object push model based on the model loss until a stop condition of model training is satisfied, to obtain the trained object push model.

7. The method according to claim 6, further comprising:
performing clustering processing on the object features corresponding to the plurality of to-be-pushed objects to obtain a plurality of clusters, each cluster being associated with at least one to-be-pushed object;
selecting a target cluster from the plurality of clusters based on a correlation between the user description feature and a cluster center corresponding to each cluster; and
selecting the candidate push object from the to-be-pushed objects associated with the target cluster based on a correlation between the user description feature and each object feature in the target cluster.

8. The method according to claim 7, wherein the interaction object information is interaction video information, the interaction video information including information of at least one video having an interaction relationship with the target user, the plurality of to-be-pushed objects are to-be-pushed videos, the object features are video features, the candidate push object is a candidate push video, and the target push object is a target push video.

9. The method according to claim 7, wherein the interaction object information is interaction product information, the interaction product information including information of at least one product having an interaction relationship with the target user, the plurality of to-be-pushed objects are to-be-pushed products, the object features are product features, the candidate push object is a candidate push product, and the target push object is a target push product.

10. A method for training an object push model, the method comprising:
obtaining a training sample, the training sample including interaction object information corresponding to a sample user, interaction user information corresponding to a sample push object, and an interaction label;
obtaining, based on the interaction object information corresponding to the sample user, a sample user description feature of the sample user from a user description feature extraction network in a to-be-trained object push model;
obtaining, based on the interaction user information corresponding to the sample push object, a sample object feature corresponding to the sample push object from an object feature extraction network in the to-be-trained object push model;
determining a model loss based on the sample user description feature, the sample object feature, and the interaction label; and
adjusting parameters of the to-be-trained object push model based on the model loss until a stop condition of model training is satisfied, to obtain a trained object push model that is configured to select a candidate push object from a plurality of to-be-pushed objects for a target user.

11. The method according to claim 10, wherein the obtaining the training sample comprises:
selecting a user from historical interaction users as the sample user;
determining the interaction object information corresponding to the sample user;
selecting an object from an object pool as the sample push object;
obtaining the interaction user information corresponding to the sample push object;
determining the interaction label based on an interaction status between the sample user and the sample push object; and
determining the training sample based on the interaction object information corresponding to the sample user, the interaction user information corresponding to the sample push object, and the interaction label.

12. The method according to claim 11, further comprising:
obtaining an object uploaded in a first preset time period before a current date; and
determining the object pool based on the uploaded object.

13. The method according to claim 11, further comprising:
displaying a first object to a first user after receiving an access request of the first user for the first object;
obtaining interaction information of the first user with respect to the first object; and
updating, based on the interaction information, interaction user information corresponding to the first object when the first object belongs to the object pool and the first user belongs to a seed user pool.

14. The method according to claim 13, further comprising:
for each user in the interaction user information corresponding to the first object:
determining whether the respective user belongs to the seed user pool; and
removing the respective user from the interaction user information corresponding to the first object when the respective user does not belong to the seed user pool.

15. The method according to claim 14, further comprising:
obtaining a plurality of interaction users who perform an interaction operation in a second preset time period before a current date; and
determining the seed user pool based on the plurality of interaction users.

16. A push object processing apparatus, comprising:
processing circuitry configured to:
obtain interaction object information corresponding to a target user, the interaction object information including information of at least one object having an interaction relationship with the target user;
determine a user description feature of the target user based on the interaction object information;
obtain interaction user information corresponding to a plurality of to-be-pushed objects, the interaction user information of each of the plurality of to-be-pushed objects including information of at least one user having an interaction relationship with the respective to-be-pushed objects;
determine, based on the interaction user information, object features corresponding to the plurality of to-be-pushed objects; and
select a candidate push object from the plurality of to-be-pushed objects based on the user description feature and the object features.

17. The apparatus according to claim 16, wherein the processing circuitry is configured to:
input the interaction object information in a trained object push model, the trained object push model including a user description feature extraction network configured to extract the user description feature from the interaction object information; and
obtain the user description feature of the target user from the trained object push model.

18. The apparatus according to claim 17, wherein the processing circuitry is configured to:
input the interaction user information in an object feature extraction network in the trained object push model; and
obtain the object features from the object feature extraction network.

19. The apparatus according to claim 18, wherein the processing circuitry is configured to:
obtain attribute information of the target user, the attribute information including at least one of user description information or identification information;
separately perform feature extraction on the interaction object information and the attribute information to obtain a first target feature corresponding to the interaction object information and a second target feature corresponding to the attribute information;
concatenate the first target feature and the second target feature to obtain a user concatenated feature; and
extract the user description feature of the target user by performing feature extraction on the user concatenated feature.

20. The apparatus according to claim 18, wherein the processing circuitry is configured to:
for each to-be-pushed object of the plurality of to-be-pushed objects:
obtain object attribute information corresponding to the respective to-be-pushed object, the object attribute information including at least one of object description information or object identification information;
separately perform feature extraction on the interaction user information of the respective to-be-pushed object and the object attribute information of the respective to-be-pushed object, to obtain a third target feature corresponding to the interaction user information of the respective to-be-pushed object and a fourth target feature corresponding to the object attribute information of the respective to-be-pushed object;
concatenate the third target feature and the fourth target feature to obtain an object concatenated feature of the respective to-be-pushed object; and
extract an object feature corresponding to the respective to-be-pushed object by performing feature extraction on the object concatenated feature.
